(19) United States
(12) Patent Application Publication
(10) Pub. No.: US 2026/0134371 A1
(43) Pub. Date: May 14, 2026

(54) SYSTEMS AND METHODS FOR MANAGING AN EVENT

(71) Applicant: Resilient Reach IP Holdings, LLC, Suwanee, GA (US)

(72) Inventor: Tiwanna Hayes, Suwanee, GA (US)

(73) Assignee: Resilient Reach IP Holdings, LLC, Suwanee, GA (US)

(21) Appl. No.: 19/387,098

(22) Filed: Nov. 12, 2025

Related U.S. Application Data
(60) Provisional application No. 63/720,057, filed on Nov. 13, 2024.

(51) Int. Cl. G06Q 10/0635

(52) U.S. Cl. CPC G06Q 10/0635

(57) ABSTRACT

A method for managing an event includes: obtaining a dependency graph including a plurality of nodes representing operational elements of the event and a plurality of edges representing relationships between the operational elements; generating, for each of the plurality of nodes, a risk vector and a readiness vector based on an analytic routine; and performing a graph updating routine, wherein the graph updating routine includes: applying a modification to a first set of nodes of the plurality of nodes; identifying a subgraph of the dependency graph based on the modification, wherein the subgraph includes a second set of nodes of the plurality of nodes; generating a modified dependency graph by updating, for each node of the second set of nodes, the risk vector and the readiness vector; and displaying the modified dependency graph.

### CROSS-REFERENCE TO RELATED APPLICATION

This application claims priority to U.S. provisional application No. 63/720,057 filed on Nov. 13, 2024. The disclosure of the above application is incorporated herein by reference.

### FIELD

The present disclosure relates to the management of an event, and more particularly, to systems and methods for predicting an outcome of one or more scenarios associated with the event.

### BACKGROUND

The statements in this section merely provide background information related to the present disclosure and may not constitute prior art.

Event management software currently focuses primarily on event planning, ticketing, and marketing. However, existing software does not consider potential disruptions that may occur in management of the event.

### SUMMARY

This section provides a general summary of the disclosure and is not a comprehensive disclosure of its full scope or all of its features.

In some embodiments, the techniques described herein relate to a method for managing an event, the method including: obtaining a dependency graph including a plurality of nodes representing operational elements of the event and a plurality of edges representing relationships between the operational elements; generating, for each of the plurality of nodes, a risk vector and a readiness vector based on an analytic routine; and performing a graph updating routine, wherein the graph updating routine includes: applying a modification to a first set of nodes of the plurality of nodes; identifying a subgraph of the dependency graph based on the modification, wherein the subgraph includes a second set of nodes of the plurality of nodes; generating a modified dependency graph by updating, for each node of the second set of nodes, the risk vector and the readiness vector; and displaying the modified dependency graph.

In one or more variations of the method of the above paragraph, which may be implemented alone or in any combination: the graph updating routine includes a scenario simulation routine or a bounded propagation routine; applying the modification further includes modifying, for each node of the first set of nodes, at least one risk score of the risk vector; the at least one risk score includes a likelihood value, an impact value, a detection confidence value, and a data quality value; the modification includes modifying, for each node of the first set of nodes, at least one readiness score of the readiness vector; the at least one readiness score includes at least one of a completion status value, an inbound risk propagation values, a service level agreement (SLA) impact factor value, and a reliance value; the analytic routine includes at least one of a graph-based analytic routine, a statistical analytic routine, a supervised learning routine, a sequence-based routine, and an unsupervised learning routine; the method further includes selectively adjusting, for a first node of the plurality nodes, at least one of the risk vector and the readiness vector when a relationship type associated with the first node is a Blocks type; a number of nodes of the second set of nodes is based on at least one of a convergence threshold and a maximum iteration count; and/or the method further includes terminating the graph updating routine when (i) at least one readiness score of the readiness vector is less than the convergence threshold or (ii) an iteration value of the graph updating routine is equal to the maximum iteration count.

In some embodiments, the techniques described herein relate to a system for managing an event, the system including: a processor; and a nontransitory computer-readable medium including instructions that are executable by the processor, wherein the instructions include: obtaining a dependency graph including a plurality of nodes representing operational elements of the event and a plurality of edges representing relationships between the operational elements; generating, for each of the plurality of nodes, a risk vector and a readiness vector based on an analytic routine; and performing a graph updating routine, wherein the graph updating routine includes: applying a modification to a first set of nodes of the plurality of nodes; identifying a subgraph of the dependency graph based on the modification, wherein the subgraph includes a second set of nodes of the plurality of nodes; generating a modified dependency graph by updating, for each node of the second set of nodes, the risk vector and the readiness vector; and displaying the modified dependency graph.

In one or more variations of the method of the above paragraph, which may be implemented alone or in any combination: the graph updating routine includes a scenario simulation routine or a bounded propagation routine; applying the modification further includes modifying, for each node of the first set of nodes, at least one risk score of the risk vector; the at least one risk score includes a likelihood value, an impact value, a detection confidence value, and a data quality value; the modification includes modifying, for each node of the first set of nodes, at least one readiness score of the readiness vector; the at least one readiness score includes at least one of a completion status value, an inbound risk propagation values, a service level agreement (SLA) impact factor value, and a reliance value; the analytic routine includes at least one of a graph-based analytic routine, a statistical analytic routine, a supervised learning routine, a sequence-based routine, and an unsupervised learning routine; the techniques described herein relate to a system, further including selectively adjusting, for a first node of the plurality nodes, at least one of the risk vector and the readiness vector when a relationship type associated with the first node is a Blocks type; a number of nodes of the second set of nodes is based on at least one of a convergence threshold and a maximum iteration count; and/or the instructions further include terminating the graph updating routine when (i) at least one readiness score of the readiness vector is less than the convergence threshold or (ii) an iteration value of the graph updating routine is equal to the maximum iteration count.

In some aspects, the techniques described herein relate to a system for managing an event, the system including: a processor; and a nontransitory computer-readable medium including instructions that are executable by the processor, wherein the instructions include: generating a dependency graph including a plurality of nodes representing operational elements of the event and a plurality of edges representing relationships between the operational elements; generating, for each of the plurality of nodes, a risk vector and a readiness vector based on an analytic routine, wherein the analytic routine includes at least one of a graph-based analytic routine, a statistical analytic routine, a supervised learning routine, a sequence-based routine, and an unsupervised learning routine; and performing a graph updating routine, wherein the graph updating routine includes a scenario simulation routine or a bounded propagation routine, and wherein the graph updating routine includes: applying a modification to a first set of nodes of the plurality of nodes; identifying a subgraph of the dependency graph based on the modification, wherein the subgraph includes a second set of nodes of the plurality of nodes; generating a modified dependency graph by updating, for each node of the second set of nodes, the risk vector and the readiness vector; and displaying the modified dependency graph. In some embodiments, applying the modification further includes modifying, for each node of the first set of nodes, at least one risk score of the risk vector and at least one readiness score of the readiness vector.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating an example computer system in accordance with one or more embodiments of the present disclosure;

FIG. 2 is a block diagram of an event management system in accordance with one or more embodiments of the present disclosure;

FIG. 3 schematically illustrates a dependency graph in accordance with one or more embodiments of the present disclosure; and

FIG. 4 is a flowchart illustrating an event management method in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides systems and methods for predicting outcomes of one or more scenarios associated with an event. Such predictions improve operational efficiency, communication, cybersecurity, and crisis management for organizations managing complex or large-scale operations and events. The artificial intelligence (AI)-driven platform described herein enables proactive management of these operations by providing real-time insights and scenario simulations that enhance resource allocation and decision-making.

In some embodiments, the event management system offers intelligent dependency mapping that provides real-time visualization of interrelated tasks and dependencies, facilitating proactive management and bottleneck identification. Using a graph-based dependency modeling approach, the event management system represents operational relationships and dependencies, enabling continuous assessment and updates without requiring full recalculation of the dependency network. The event management system may also include impact modeling features that employ predictive analytics to simulate outcomes and enhance decision-making across multiple scenarios. Through proactive cyberthreat defense capabilities, the platform detects and mitigates potential threats in real time, enhancing operational security.

In some embodiments, the event management system may also include a comprehensive graphical user interface (GUI) that dynamically presents and updates operational data, improving both user efficiency and interaction performance. The GUI enables guided input of data sets and displays predictive results in an intuitive format, thereby improving human-machine interaction and overall usability.

In some embodiments, the event management system facilitates simulation and evaluation of possible scenarios based on received data sets. The system maps interdependencies among data sets, assigns risk and readiness scores to each operational pathway, and determines optimal responses. Through these simulations, users can view and select specific scenarios that improve decision-making by providing predictive insights into potential outcomes. In some embodiments, the event management system may automatically process multiple data sets from various sources related to an event, thereby increasing the likelihood of generating desirable and realistic scenarios. Processing a greater number of data sets enhances the system's decision-making accuracy and operational readiness, while reducing computational overhead through efficient, bounded propagation techniques. That is, unlike conventional event management systems that require global recomputation, the disclosed system improves computing efficiency by performing bounded recomputation and selective subgraph analysis, reducing the computational complexity of real-time updates.

In some embodiments, the event management system performs real-time learning routines to continuously adapt and improve performance based on incoming operational data and feedback. These routines allow for dynamic adjustment of predictions and readiness assessments, improving resilience and accuracy in event management operations.

The event management system may further implement orchestration routines that coordinate between operational elements, assessing task dependencies, resource availability, and timeline constraints to generate predictive readiness insights. This orchestration enables proactive identification of potential issues and supports timely intervention to maintain operational objectives.

The embodiments described herein provide an integrated, AI-driven event management platform that delivers real-time, actionable insights, enhances operational efficiency, and improves the underlying computing functionality. By combining dependency mapping, predictive modeling, cybersecurity, and orchestration capabilities, the event management system provides organizations with a tailored, adaptive framework that anticipates and mitigates operational risks.

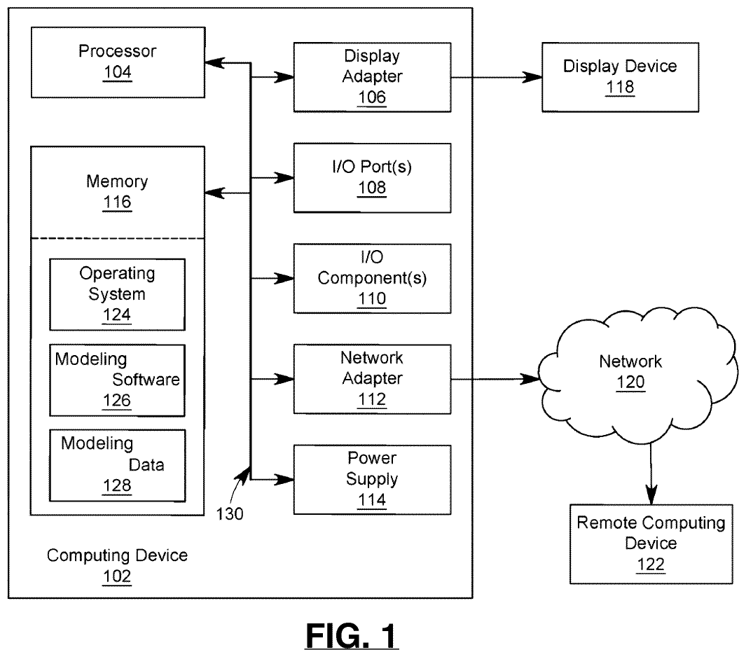

FIG. 1 illustrates an operating environment that facilitates the performance of the one or more systems and methods described herein. In some embodiments, the systems and methods described herein can be implemented using the computing device 102. For example, the computing device 102 can be a personal computer, a desktop, a laptop, a tablet, a hand-held computer, a server, a workstation, a mainframe, a wearable computer, a supercomputer, or a combination thereof. However, it is understood that the above-referenced examples of the computing device 102 is non-exhaustive and the computing device 102 can be any type of processing or computing device.

In some embodiments, the computing device 102 may include a processor 104, a display adapter 106, one or more input/output port(s) 108, one or more input/output component(s) 110, a network adapter 112, a power supply 114, and a memory 116. However, it is understood that the computing device 102 can include any additional components therein and is not required to include any of the listed components (e.g., the processor 104, the display adapter 106, the one or more input/output port(s) 108, the one or more input/output component(s) 110, the network adapter 112, the power supply 114, and the memory 116).

In some embodiments, the processor 104 is configured to provide instructions to the computing device 102 so that the computing device 102 can process one or more tasks including the implementation of a software program to perform one or more operations as described in more detail herein. It is also understood that the computing device 102 may include any number or processors 104 therein. For example, the processor 104 may be integrated with any other existing systems (e.g., ERP, CRM, project management tools, etc.) to utilize any data elements as described herein. As another example, the processor 104 can perform and/or facilitate performance of one or more security measures including end-to-end encryption for any and all transmission of data; multi-factor authentication for platform access; role-based access control that provides only authorized users can access sensitive data; or a combination thereof.

In some embodiments, the display adapter 106 can be a graphics card or a video board that provides the computing device 102 with a capability to display content on a display device 118. For example, the display device 118 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the above-referenced examples of the display device 118 is non-exhaustive, and the display device 118 can be any type of device capable of providing a visual display.

In some embodiments, the input/output port(s) 108 provide interfaces (e.g., sockets) for one or more cables to connect to the computing device 102. It is understood that there may be any number of input/output port(s) 108 on the computing device 102. For example, the input/output port(s) 108 enables the reception of signals and/or data from an external device connected to the computing device 102 via the one or more cables. As another example, the input/output port(s) 108 enables the transmission of signals and/or data to an external device connected to the computing device 102 via the one or more cables. The input/output component(s) 110 can include one or more components that support the input/output port(s) 108 such as, but not limited to, a switch, a push button, a pressure mat, a float switch, a keypad, a radio receive, or a combination thereof.

The network adapter 112 can be any type of network interface controller that enables communication over a network 120 with another computing device, such as a remote computing device 122. For example, the network 120 may be a secure and scalable cloud infrastructure capable of hosting a platform for providing flexible and accessible management of an event, as is described herein. As an example, the remote computing device 122 can be a user device, such as a cellular-phone, a smartphone, a tablet, a laptop, or a combination thereof. The power supply 114 is configured to convert alternating high voltage current (e.g., AC) into direct current (e.g., DC) to provide regulated power to the other components (e.g., the processor 104, the display adapter 106, the one or more input/output port(s) 108, the one or more input/output component(s) 110, the network adapter 112, and the memory 116) of the computing device 102.

Additionally, the memory 116 can be a mass storage device and/or a system memory such as a hard disk drive, a memory card, a solid-state drive, random access memory (RAM), or a combination thereof. The memory 116 is configured to store instructions and data associated with the operation of the computing device 102. For example, the data associated with the operation of the computing device 102 can include operational data, dependency data, risk data, readiness data, impact data cybersecurity data, or a combination thereof. As another example, the operational data can include task details, timeliness, resource allocation, or a combination thereof. As yet another example, the dependency data can include interconnections between tasks, teams, resources, or a combination thereof. As a further example, the risk data can include historical data, predictive analytical outputs, risk scores, or a combination thereof. For example, the readiness data can include task completion percentages, readiness scores, or a combination thereof. As an additional example, the impact data can include scenario outcomes, potential downstream effects, or a combination thereof. As a further example, the cybersecurity data can include threat detection logs, encrypted communications, or a combination thereof. The memory 116 can generally include an operating system 124, modeling software 126, and modeling data 128. For example, the operating system 124 is configured to manage and/or process any of the data and/or instructions associated with the modeling software 126 and/or modeling data 128, as described in more detail herein.

Furthermore, a system bus 130 is also included within the computing device 102 that is configured to couple each of the various components (e.g., the processor 104, the display adapter 106, the one or more input/output port(s) 108, the one or more input/output component(s) 110, the network adapter 112, the power supply 114, and the memory 116) of the computing device 102. It is also understood that each of the components of the computing device 102, and the functionality associated with each of the components of the computing device 102, may be implemented within the remote computing device 122. While the operating environment illustrated within FIG. 1 depicts a particular configuration associated with at least the computing device 102, the network 120, and the remote computing device 122, it is understood that the operating environment may be configured in any way.

In some embodiments, the computing device 102 is configured to identify, asses, and/or mitigate any operational risks associated with managing a workflow associated with an event. It is understood that the event can be any planned occasion such as, but not limited to, a sporting event, large gathering, or a musical event. It is also understood that the even can be any unplanned occasion. As such, the various embodiments described herein can be used in connection with any type of event or gathering (formal or otherwise). It is also understood that the workflow can be, but is not limited to, a business process associated with the event, a security process associated with the event, among others.

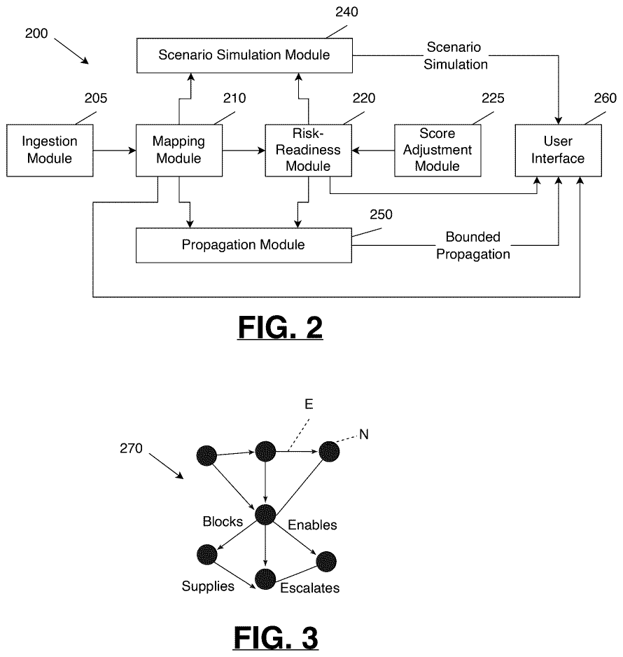

For example, and referring to FIG. 2, the computing device 102 is implemented within an example event management system 200, which includes an ingestion module 205, a mapping module 210, a risk-readiness module 220, a score adjustment module 225, a scenario simulation module 240, a propagation module 250, and a user interface 260.

In some embodiments, the ingestion module 205 is configured to obtain one or more data sets. For example, the one or more data sets is obtained as part of an onboarding process. As another example, the one or more data sets can be received from one or more sources including, but not limited to, a governing organization associated with the event and/or any vendors associated with the event. As yet another example, the one or more data sets can include organizational data, one or more training manuals, organization chart(s), organizational operating procedures, one or more tasks, one or more dependencies, one or more risks, one or more resources, or a combination thereof. It is understood, however, that the one or more data sets can include any data elements associated with the event.

In some embodiments, the mapping module 210 is configured to model operational dependencies and relationships of the one or more data sets. In some embodiments, and with reference to FIGS. 2-3, the mapping module 210 represents operations as a dependency graph 270, where nodes N represent individual tasks, activities, or operational elements, and edges E represent relationships between these elements. The dependency graph 270 provides a computational framework for tracking relationships between operational tasks, resources, and events within complex event management scenarios.

In some embodiments, the dependency graph 270 utilizes typed edges that define specific relationship categories between nodes. The typed edges may include, but are not limited to, Precedes, Enables, Blocks, Supplies, and Escalates relationships. Precedes relationships may establish temporal ordering between operational tasks. Enables relationships may define conditional dependencies where one node must be completed or activated before another node can proceed. Supplies relationships may indicate resource provision dependencies where one node provides resources, data, or services to another node. Escalates relationships define hierarchical dependencies where issues or status changes in one node trigger elevated priority or attention in connected nodes. Blocks relationships may represent inhibitory connections where one node prevents or delays the execution of another node.

In some embodiments, each edge in the dependency graph 270 is configured with multiple attribute parameters that quantify the relationship characteristics, such as criticality levels, temporal slack values, reliance factors, service level agreement (SLA) impact measurements, and/or confidence scores. The criticality attribute measures the importance of the dependency relationship on a numerical scale, indicating how failure or delay in the relationship affects overall system performance. The temporal slack attribute represents the available time buffer between connected nodes and may be measured in time units, such as minutes or hours. The reliance attribute quantifies the degree of dependence between nodes, indicating how strongly one node depends on another for successful completion. The SLA impact attribute measures the effect of the dependency relationship on SLA compliance and may be expressed as a numerical impact score. The confidence attribute represents the reliability or certainty of the dependency relationship and may be expressed as a probability value between 0 and 1.

In some embodiments, nodes within the dependency graph maintain multiple attribute categories that track operational state and performance metrics. The status attribute records the current operational state of each node, such as pending, active, completed, or failed states. The completion attribute tracks the percentage or degree of task completion for each node and may be represented as a value between 0 and 100 percent. The signals attribute stores real-time data inputs, alerts, or notifications associated with each node, which are used for monitoring and decision-making processes. The risk scores attribute maintains calculated risk assessment values that quantify potential negative outcomes or failures associated with each node. The readiness scores attribute stores computed readiness metrics that indicate how prepared or capable each node is to execute its assigned operations.

Accordingly, the dependency graph 270 enables the system to model complex operational relationships by connecting nodes through the typed edge relationships while maintaining detailed attribute information at both the node and edge levels. The dependency graph 270 allows for dynamic updates to node attributes as operational conditions change, while the edge attributes provide context for how changes propagate through the dependency graph 270. The combination of typed edges and comprehensive attribute systems creates a detailed operational model that supports real-time monitoring, risk assessment, and predictive analysis for event management scenarios.

In some embodiments, the risk-readiness module 220 processes the node and edge data of the dependency graph 270 to generate quantitative assessments. As an example, the risk-readiness module 220 computes risk vectors for each node, where each risk vector comprises likelihood values, impact values, detection confidence values, and data quality values.

The likelihood value may represent the probability that a particular risk event will occur at a given node, and it may be expressed as a numerical value between 0 and 1, where higher values indicate greater probability of occurrence. For example, a node representing equipment setup for an outdoor event receives a higher likelihood score during periods of forecasted severe weather compared to clear weather conditions. The impact value may quantify the magnitude of consequences that would result if the risk event materializes, measures the potential disruption to downstream operations, measures resource requirements for remediation, and measures overall effect on event readiness. For example, a power system failure at a venue receives a higher impact score than a minor audio equipment malfunction due to the broader operational consequences. The detection confidence value may indicate the reliability and accuracy of the data sources used to assess the risk. This component accounts for sensor accuracy, data freshness, and the completeness of available information. For example, real-time sensor data from monitored equipment provides higher detection confidence compared to manually reported status updates that is obsolete. The data quality value may evaluate the integrity and consistency of the underlying information used in risk assessment, and it may consider factors such as data completeness, consistency across multiple sources, and the presence of anomalies or outliers. For example, automated data feeds from integrated systems may provide higher data quality scores compared to manually entered information that is subject to human error.

In some embodiments, each value of the risk vector is weighted to reflect the relevance of that value within a specific operational context. The weighted combination process allows the system to adapt risk calculations to different operational contexts and priorities, as different event types, venues, and operational phases utilize different weighting factors to emphasize relevant risk components for each specific situation.

As an example, for a security checkpoint node during a large sporting event, the likelihood value receives a moderate score based on historical crowd flow patterns and current attendance projections. Furthermore, the impact value receives a high score because security delays affect multiple downstream operations including concession sales, seating, and emergency egress procedures. The detection confidence value may receive a high score due to real-time crowd monitoring sensors and automated turnstile data. The data quality value may receive a moderate score because some manual security reports supplement the automated data streams. Accordingly, the weighted combination of these values produces a risk score that reflects the overall risk profile of the security checkpoint operation.

As another example, for a catering preparation node, the likelihood value receives a low score when adequate preparation time remains, and all ingredients are confirmed available. Furthermore, the impact value receives a moderate score because catering delays affect guest satisfaction but do not prevent the event from proceeding. The detection confidence value may receive a high score due to integrated inventory management systems and real-time preparation tracking, and the data quality component may receive a high score because automated systems provide consistent and complete information. Accordingly, the resulting risk vector reflects the relatively low overall risk associated with the catering operation under these conditions.

In some embodiments, the risk-readiness module 220 also generates readiness vectors for one or more of the nodes, where each of the readiness vectors includes one or more readiness scores. As an example, the readiness scores may be generated using monotonic functions (e.g., where higher completion levels and lower risk factors produce increased readiness values) that are based on completion status values, inbound risk propagation values, SLA impact factor values, and reliance values.

In some embodiments, the completion status value represents the current progress state of a task or operation within the dependency graph 270, and the completion status value may be a normalized value between zero and one, where zero indicates no progress and one represents full completion. In some embodiments, the inbound risk propagation value indicates a risk propagation from upstream dependencies within the dependency graph 270. As an example, the risk-readiness module 220 aggregates risk values from connected predecessor nodes and applies weighting factors based on the strength and type of dependency relationships. Higher inbound risk values reduce the readiness score for the target node, reflecting the potential impact of upstream issues on downstream operations.

In some embodiments, the SLA impact factor value indicates the potential consequences of delays or failures on contractual obligations and performance targets. The risk-readiness module 220 assigns impact weights based on the severity of potential SLA violations, with operations having greater SLA exposure receiving higher impact scores. In some embodiments, the SLA impact factor value impacts inversely affects readiness scores, where higher SLA impact reduces the computed readiness value. In some embodiments, the reliance values quantify the degree of dependency between connected nodes in the dependency graph 270. The risk-readiness module 220 may determine the reliance value based on the number and strength of incoming dependencies, with nodes having multiple or strong dependencies receiving higher reliance scores. Increased reliance may reduce readiness scores, as highly dependent operations may face greater vulnerability to upstream disruptions. In some embodiments, each readiness score of the readiness vector is weighted to reflect the relevance of that value within a specific operational context in a similar manner as the risk scores of the risk vector.

To perform the functionality described herein, the risk-readiness module 220 may perform one or more analytic routines, such as graph-based analytic routines, statistical analytic routines, supervised learning routines, sequence-based routines, and/or unsupervised learning routines. The implementation of multiple routines may provide a comprehensive analytical framework where each method contributes specialized capabilities to the overall risk and readiness assessment process. As an example, the graph-based analytic routine may provide structural understanding, statistical analytic routines may offer predictive insights, supervised learning routines may enable pattern-based classification, sequence-based routines may capture temporal dynamics, and unsupervised routines may detect anomalous conditions.

In some embodiments, graph-based analytic routines may include propagation routines, path minima calculations routines, and centrality-informed bottleneck identification routines. As an example, the propagation routines may include traversing the dependency graph 270 while considering the specific characteristics of each node and edge relationship. As another example, path minima calculation routines may identify bottleneck points within dependency chains by analyzing the minimum capacity or readiness values along critical pathways. As another example, centrality-informed bottlenecking routines may include evaluating node importance based on graph centrality measures, allowing the risk-readiness module 220 to prioritize nodes that have the greatest influence on overall event readiness.

In some embodiments, statistical analytic routines may include linear-based and logistic-based relationship analysis between input variables and outcome probabilities, generating probability estimates for various risk scenarios. For example, the statistical analytic routines may include exponentially weighted moving average (EMWA) routines that track trending patterns in data streams by applying greater weight to recent observations while maintaining historical context. As another example, the statistical analytic routines may include statistical process control (SPC) drift detection routines that monitor data streams for statistically significant deviations from established baseline patterns, triggering alerts when process variations exceed control limits.

In some embodiments, the supervised learning routines enhance the event management system's 100 pattern recognition capabilities through trained classification and regression algorithms. As an example, the supervised learning routines may include tree-ensemble model routines, including random forest and gradient boosting routines, which analyze feature interactions to predict risk levels and readiness states. These supervised classifiers may process multiple input features simultaneously to generate classification outputs that inform risk assessment decisions. The supervised learning models learn from labeled training examples to identify patterns that correlate with specific risk or readiness outcomes.

In some embodiments, the sequence-based routines may analyze temporal patterns within the data set to identify time-dependent relationships and trends. These models process sequential data inputs to detect patterns that emerge over time, such as recurring failure modes or predictable performance degradation cycles. The sequence analysis capabilities enable the system to anticipate future states based on observed temporal progressions in the data set. In some embodiments, the unsupervised learning routines may identify anomalous patterns or outliers without requiring pre-labeled training data. As an example, autoencoding routines may learn normal operational patterns by training neural networks to reconstruct input data, with reconstruction errors serving as anomaly indicators.

In some embodiments, the score adjustment module 225 is configured to selectively adjust the risk scores and/or readiness scores generated by the risk-readiness module 220 based on one or more rules. As an example, the one or more rules may include a blocking rule for dependencies having a “Blocks” relationship, which includes adjusting the aggregated value of the readiness vector to zero. For example, in a sports event scenario, a field preparation task may depend on equipment delivery and weather clearance. If equipment delivery is marked as a blocking dependency (i.e., a “Blocks” relationship) and remains incomplete, the score of the aggregated value of the readiness vector is adjusted to zero despite favorable weather conditions and available personnel. As another example, the one or more rules may include a critical path penalty rule, which includes reducing the aggregate readiness score when critical path nodes experience low readiness values or blocking conditions exist. As an example, if a critical path node shows 60% readiness while non-critical nodes average 90% readiness, the penalty adjustment reduces the overall aggregate score below the simple weighted average to reflect the disproportionate impact of critical path delays. The penalty calculation applies multiplicative factors based on critical path node performance, where critical path readiness below threshold values triggers progressively larger penalty adjustments.

To perform the functionality described herein, the score adjustment module 225 is configured to employ rule-based evaluators, temporal gates, and/or exception dictionaries. Rule-based evaluators may implement SLA threshold evaluators that compare current performance metrics against predefined SLA parameters. Temporal gates may function as time-based decision points that evaluate whether specific conditions are met within designated time windows. Exception dictionaries may maintain collections of predefined scenarios and their corresponding response protocols, enabling identification and handling of known problematic conditions.

In some embodiments, the scenario simulation module 240 is configured to perform predictive analytic-based routines on the dependency graph 270 scenarios as modifications to nodes and edges of the dependency graph 270 within specified time windows, along with associated objectives and constraints. As an example, the scenario simulation module 240 may copy the dependency graph 270, applies the defined modifications (e.g., increasing the completion status of a security checkpoint node from 60% to 100% within a two-hour time window), identifies affected subgraphs, and determines the risk and readiness scores for the impacted nodes of the affected subgraph.

Accordingly, the scenario simulation module 240 may evaluate multiple scenarios in parallel that identify trade-offs between different approaches (e.g., a high-cost scenario achieving 95% readiness against a moderate-cost scenario achieving 87% readiness) with improved computational efficiency. That is, multiple scenario simulations may run concurrently by creating independent copies of the dependency graph 270 and applying different modification sets to each copy. Moreover, by determining the risk vectors and readiness scores for nodes within the affected subgraphs as opposed to the entire dependency graph 270, the amount of computing resources (e.g., processor-based, resource-based, and/or time-based resources).

The propagation module 250 is configured to update the dependency graph 270 by performing a bounded propagation routine. In some embodiments, the bounded propagation routine employs a priority queue of downstream edges to manage the propagation of changes through the dependency graph 270. In some embodiments, the priority queue organizes edges based on propagation priority, ensuring that changes flow through the graph in an ordered manner. The bounded propagation routine may process changes by selecting edges from the priority queue based on their propagation weights, which may be determined by factors such as edge criticality, temporal urgency, and dependency strength. The bounded propagation routine may calculate updated risk and readiness vectors for target nodes by applying propagation functions that consider the magnitude of change, edge attributes, and existing node states. The bounded propagation routine may be iteratively performed, with each iteration adding newly affected downstream edges to the priority queue until convergence criteria are satisfied.

In some embodiments, the propagation module 250 terminates propagation calculations when incremental changes fall below a predetermined convergence threshold ε is reached (i.e., indicating that further propagation would produce negligible effects) or when a maximum iteration count θ is reached (e.g., a computational bound regardless of convergence behavior). That is, the number of nodes in the subgraph may be based on at least one of the convergence threshold and the maximum iteration count, where the propagation routine continues adding downstream nodes to the affected set until either the convergence criteria is satisfied or the maximum iteration count θ is exceeded. Accordingly, the bounded propagation routine reduces the computational complexity from O(N) for a full dependency graph update to O(k·d), where k represents the number of affected nodes and d represents the average node degree.

As an example, when the dependency graph 270 includes 10,000 nodes having 50 nodes are affected by a status update, and where each node has an average of 5 connections, the computational requirement reduces from 10,000 operations to approximately 250 operations to propagate the updates to the dependency graphs 270. As a more specific example, when a venue security checkpoint node experiences a status change from “delayed” to “operational,” the bounded propagation routine may first update the immediately connected concession stand nodes, then propagate to seating management nodes, and finally to emergency egress nodes. In this scenario, if the security checkpoint change affects 15 downstream nodes (as indicated by the convergence threshold and/or the maximum iteration count) with an average of 3 edge connections each, the bounded propagation processes approximately 45 edge updates rather than recalculating the entire 10,000-node dependency graph, thereby reducing computational overhead while maintaining accuracy in the affected operational areas.

In some embodiments, the user interface 260 is configured to provide real-time visualization and interaction capabilities. As an example, the user interface 260 may display the dependency graph 270, one or more scores of the risk vectors, and/or one or more scores of the readiness vectors. As another example, the user interface 260 receives updates from the risk-readiness module 220 to display current readiness states and automatically refresh displayed information as conditions change. As yet another example, the user interface 260 visualizes the dependency relationships from the mapping module 210, highlights paths identified as having high impact on overall readiness, and presents ranked mitigation options generated by the scenario simulation module 240. In some embodiments, the user interface 260 may include comparison views that display readiness changes, resource requirements, and implementation timeframes to support rapid decision-making processes. To perform the functionality described herein, the user interface 260 may include a display panel, one or more input devices such as a touchscreen, keyboard, or pointing device, and a processing module configured to receive user input signals, generate corresponding control commands, and present visual or graphical output on the display in response to user interactions.

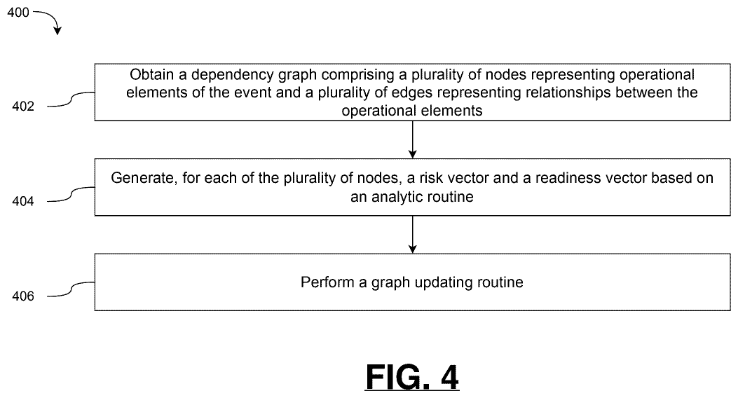

Referring to FIG. 4, a flowchart of a method 400 for managing an event is shown. The method 400 begins at step 402, where the event management system 200 obtains a dependency graph comprising a plurality of nodes representing operational elements of the event and a plurality of edges representing relationships between the operational elements (e.g., the dependency graph 270). At step 404, the event management system 200 generates, for each of the plurality of nodes, a risk vector and a readiness vector based on an analytic routine. At step 406, the event management system 200 performs a graph updating routine (e.g., a scenario simulation routine or a bounded propagation routine). In some embodiments, the graph updating routine may include applying a modification to a first set of nodes of the plurality of nodes and identifying a subgraph of the dependency graph based on the modification (e.g., a subgraph of the dependency graph 270). The graph updating routine may also include generating a modified dependency graph by updating, for each node of the second set of nodes, the risk vector and the readiness vector and displaying, using the user interface 260, the modified dependency graph.

As described herein, the event management system 200 provides a comprehensive solution for managing complex events through dependency modeling, risk assessment, and predictive analytics. The system may utilize graph-based representations to model operational relationships and dependencies, enabling real-time monitoring and proactive management of event operations. Through the combination of multiple analytic routines including graph-based, statistical, supervised learning, sequence-based, and unsupervised learning approaches, the event management system 200 may generate accurate risk and readiness assessments that inform decision-making processes. The bounded propagation and scenario simulation capabilities may reduce computational overhead while maintaining accuracy, allowing organizations to evaluate multiple operational scenarios efficiently. This integrated approach may improve operational efficiency by providing real-time insights into event readiness, enabling proactive identification of potential issues, and supporting rapid response to changing conditions.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice; material, manufacturing, and assembly tolerances; and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, the term controller or module may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality, such as, but not limited to, movement drivers and systems, transceivers, routers, input/output interface hardware, among others; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

What is claimed is:

1. A method for managing an event, the method comprising:
obtaining a dependency graph comprising a plurality of nodes representing operational elements of the event and a plurality of edges representing relationships between the operational elements;
generating, for each of the plurality of nodes, a risk vector and a readiness vector based on an analytic routine; and
performing a graph updating routine, wherein the graph updating routine comprises:
applying a modification to a first set of nodes of the plurality of nodes;
identifying a subgraph of the dependency graph based on the modification, wherein the subgraph comprises a second set of nodes of the plurality of nodes;
generating a modified dependency graph by updating, for each node of the second set of nodes, the risk vector and the readiness vector; and
displaying the modified dependency graph.

2. The method of claim 1, wherein the graph updating routine comprises a scenario simulation routine or a bounded propagation routine.

3. The method of claim 1, wherein applying the modification further comprises modifying, for each node of the first set of nodes, at least one risk score of the risk vector.

4. The method of claim 3, wherein the at least one risk score comprises a likelihood value, an impact value, a detection confidence value, and a data quality value.

5. The method of claim 1, wherein the modification comprises modifying, for each node of the first set of nodes, at least one readiness score of the readiness vector.

6. The method of claim 5, wherein the at least one readiness score comprises at least one of a completion status value, an inbound risk propagation values, a service level agreement (SLA) impact factor value, and a reliance value.

7. The method of claim 1, wherein the analytic routine comprises at least one of a graph-based analytic routine, a statistical analytic routine, a supervised learning routine, a sequence-based routine, and an unsupervised learning routine.

8. The method of claim 1, further comprising selectively adjusting, for a first node of the plurality nodes, at least one of the risk vector and the readiness vector when a relationship type associated with the first node is a Blocks type.

9. The method of claim 1, wherein a number of nodes of the second set of nodes is based on at least one of a convergence threshold and a maximum iteration count, and wherein the method further comprises terminating the graph updating routine when (i) at least one readiness score of the readiness vector is less than the convergence threshold or (ii) an iteration value of the graph updating routine is equal to the maximum iteration count.

10. A system for managing an event, the system comprising:
a processor; and
a nontransitory computer-readable medium comprising instructions that are executable by the processor, wherein the instructions comprise:
obtaining a dependency graph comprising a plurality of nodes representing operational elements of the event and a plurality of edges representing relationships between the operational elements;
generating, for each of the plurality of nodes, a risk vector and a readiness vector based on an analytic routine; and
performing a graph updating routine, wherein the graph updating routine comprises:
applying a modification to a first set of nodes of the plurality of nodes;
identifying a subgraph of the dependency graph based on the modification, wherein the subgraph comprises a second set of nodes of the plurality of nodes;
generating a modified dependency graph by updating, for each node of the second set of nodes, the risk vector and the readiness vector; and
displaying the modified dependency graph.

11. The system of claim 10, wherein the graph updating routine comprises a scenario simulation routine or a bounded propagation routine.

12. The system of claim 10, wherein applying the modification further comprises modifying, for each node of the first set of nodes, at least one risk score of the risk vector.

13. The system of claim 12, wherein the at least one risk score comprises a likelihood value, an impact value, a detection confidence value, and a data quality value.

14. The system of claim 10, wherein the modification comprises modifying, for each node of the first set of nodes, at least one readiness score of the readiness vector.

15. The system of claim 14, wherein the at least one readiness score comprises at least one of a completion status value, an inbound risk propagation values, a service level agreement (SLA) impact factor value, and a reliance value.

16. The system of claim 10, wherein the analytic routine comprises at least one of a graph-based analytic routine, a statistical analytic routine, a supervised learning routine, a sequence-based routine, and an unsupervised learning routine.

17. The system of claim 10, further comprising selectively adjusting, for a first node of the plurality nodes, at least one of the risk vector and the readiness vector when a relationship type associated with the first node is a Blocks type.

18. The system of claim 10, wherein a number of nodes of the second set of nodes is based on at least one of a convergence threshold and a maximum iteration count, and wherein the instructions further comprise terminating the graph updating routine when (i) at least one readiness score of the readiness vector is less than the convergence threshold or (ii) an iteration value of the graph updating routine is equal to the maximum iteration count.

19. A system for managing an event, the system comprising:
a processor; and
a nontransitory computer-readable medium comprising instructions that are executable by the processor, wherein the instructions comprise:
generating a dependency graph comprising a plurality of nodes representing operational elements of the event and a plurality of edges representing relationships between the operational elements;
generating, for each of the plurality of nodes, a risk vector and a readiness vector based on an analytic routine, wherein the analytic routine comprises at least one of a graph-based analytic routine, a statistical analytic routine, a supervised learning routine, a sequence-based routine, and an unsupervised learning routine; and
performing a graph updating routine, wherein the graph updating routine comprises a scenario simulation routine or a bounded propagation routine, and wherein the graph updating routine comprises:
applying a modification to a first set of nodes of the plurality of nodes;
identifying a subgraph of the dependency graph based on the modification, wherein the subgraph comprises a second set of nodes of the plurality of nodes;
generating a modified dependency graph by updating, for each node of the second set of nodes, the risk vector and the readiness vector; and
displaying the modified dependency graph.

20. The system of claim 19, wherein applying the modification further comprises modifying, for each node of the first set of nodes, at least one risk score of the risk vector and at least one readiness score of the readiness vector.
